(19) United States
(12) Patent Application Publication
(10) Pub. No.: US 2008/0165633 A1
(43) Pub. Date: Jul. 10, 2008

(54) DEVICE AND METHOD FOR COMPENSATING SIGNAL IN A LIGHT-SCRIBE SYSTEM

(76) Inventors: YI-LONG HSIAO, Taoyuan County (TW); I-BING SU, Taoyuan County (TW)

Correspondence Address: G. LINK CO., LTD., 3550 BELL ROAD, MINOOKA, IL, 60447, US

(21) Appl. No.: 11/968,443

(22) Filed: Jan. 2, 2008

(30) Foreign Application Priority Data
Jan. 5, 2007 (TW) 096100745

(51) Int. Cl. G11B 7/00

(52) U.S. Cl. 369/44.32

(57) ABSTRACT

The present invention provides a device and method for compensating signal in a light-scribe system. A light processing unit processes the reflection received by a light emitter to form a pulse wave. A microprocessor receives the pulse signal and detects the loss of pulse wave with a detector. A timer counts the interruption time of the pulse wave. A comparator compares the interruption time to a threshold. If the interruption time is greater than the threshold, a pulse generator produces a replacing pulse wave. A logical circuit receives the pulse wave and the replacing pulse wave, outputs the pulse wave from the light processing unit if there is loss of pulse wave, and outputs the replacing pulse wave if there is no pulse wave loss.

### FIELD OF THE INVENTION

The present invention relates to a light-scribe system in an optical disc drive, more particularly a device and method for compensating the loss of pulse position signal during the process of disc label in a light-scribe system.

### BACKGROUND OF THE INVENTION

An optical disc drive with light-scribe system can use the laser of the pickup head to read and write the data on the data side of the disc and use the same pickup head laser to mark directly the texts and graphics which the user desires on the non-data side of disc.

FIG. 1 shows the basic configuration of a conventional light-scribe system 10. In the production of label by the light-scribe system 10, let the non-data side of optical disc 11 face the pickup head 12 of the light-scribe system 10 and command the activation of the light-scribe system 10. The digital signal processing unit 13 of the light-scribe system 10 transmits the signal to the motor server unit 14 and pickup head server unit 15. The motor server unit 14 controls the turning of the spindle motor 16, which drives the rotation of optical disc 11. At the same time, the pickup head server unit 15 controls the pickup head 12 to emit a laser beam to the optical disc 11 and move back and forth radially along the optical disc 11 to mark the label texts and graphics on the non-data side of the optical disc 11.

To meet the specifications of the light-scribe system, about 400 radial spokes 17 are formed on the specific radius of the non-data side of optical disc 11 to form a spoke ring that covers comparably 360 degrees circle of the optical disc 11, and divides the circle into 360/400 angles to position the markings of texts and graphics by pickup head 12. To obtain the position angle of the optical disc 11, the light-scribe system 11 is arranged with a light emitter 18 at the location opposing the spoke ring. The light emitter 18 projects a light beam to the spoke ring and receives the reflected light from it, and then transmits the light signal to the light processing unit 19 where the light signal is converted into an electric signal.

FIG. 2 shows a sectional view of the spokes 17 on the optical disc 11. The spokes 17 following dyeing and molding would affect the reflection of the projected beams from the light emitter 18, thereby resulting in different intensities of light reflection between the areas of disc with spokes 17 and without spokes 17. When the optical disc 11 turns, the laser emitted by the light emitter 18 crosses alternately the spoke area and the non-spoke area to transmit the different intensities of reflections received to the light processing unit, which are then converted into pulse signals. For 400 spokes 17, the light emitter 18 theoretically can produce 400 pulses P after one track of optical disc 11. The light-scribe system can then use the pulse count after one track to identify the angle of the pickup head 12 on the optical disc 11 and have the pickup head server unit 15 move radially the distance of the pickup head 12 to position the angle and location of pickup head 12 on the optical disc 11 for precise marking of the texts and graphics.

However given the minute size of the spokes, uneven dyeing or improper molding in the disc production process is prone to lead to poor-quality spokes. Even with good spokes, the substandard quality of the light emitter or light processing unit will cause poor light reception which results in blurry or missed signals. In addition, disc runout tends to change the relative position of the optical disc to the light emitter, more often obstructing the reception of reflected light and resulting in lost pulses. The myriad factors mentioned above all affect the correct positioning of the pickup head, which would lead to deformation of the marked texts and graphics or even mismarking of label. Thus the positioning of pickup head presents a problem to be addressed for the light-scribe system of an optical disc drive.

### SUMMARY OF THE INVENTION

The object of the invention is to provide a device and method for compensating signal in a light-scribe system to detect lost pulse waves and generate pulse waves of predefined circle to compensate the lost pulse waves and maintain correct positions in label marking.

Another object of the invention is to provide a device and method for compensating signal in a light-scribe system that uses the generation of replacing pulse wave to overcome poorly manufactured or assembled light-scribe system so as to help lower the production cost.

Yet another object of the invention is to provide a device and method for compensating signal in a light-scribe system to compensate for lost pulse waves and minimize the impact of environmental factors such as vibration on the light-scribe system so as to improve its reliability.

To achieve the aforesaid objects, the device for compensating signal in a light-scribe system of the invention comprises a light processing unit to process the reflection received by a light emitter to form a pulse wave: a microprocessor to receive the pulse wave from the light processing unit and detect the loss of pulse wave with a detector; a timer to count the interruption time of pulse wave; a comparator to compare the interruption time to a threshold; a pulse generator to produce a replacing pulse wave if the interruption time is greater than the threshold; and a logical circuit to receive the pulse wave from the light processing unit and the replacing pulse wave from the microprocessor and to output the pulse wave from the light processing unit if the pulse wave is not lost, or to output the replacing pulse wave if the pulse wave is lost.

The method for compensating the signal in a light-scribe system comprises the steps of first activating a light-scribe system to receive pulse wave signal formed by the reflection of an optical disc; detecting the interruption of pulse wave signal; counting the interruption time of pulse wave; comparing the interruption time with a preset threshold; generating a replacing pulse wave of predefined cycle based on the radial location of pickup head on optical disc if the interruption time is greater than the threshold; and outputting the pulse wave or the replacing pulse wave.

### BRIEF DESCRIPTION OF THE DRAWINGS

FIG. 1 is the configuration of a conventional light-scribe system of optical disc drive;

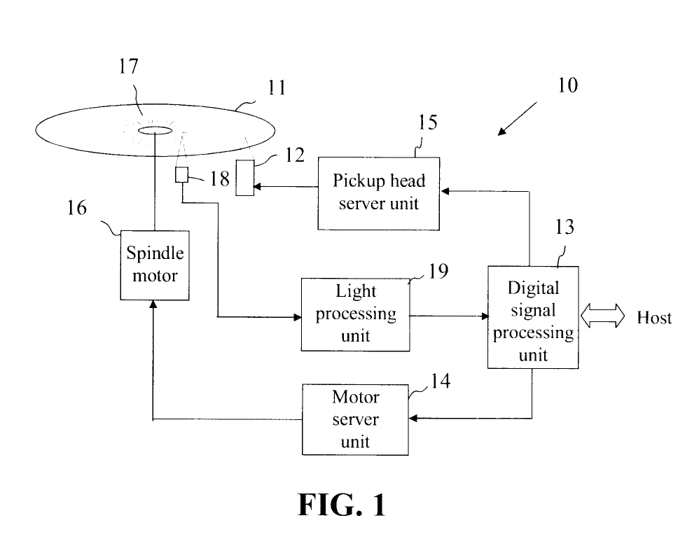

FIG. 2 is a sectional view of spokes on a conventional optical disc forming pulse waves;

FIG. 3 is a configuration of a light-scribe system according to the invention;

FIG. 4 is a configuration of the microprocessor in a light-scribe system according to the invention; and

FIG. 5 is a flow chart of the method for compensating signal in a light-scribe system according to the invention.

### DETAILED DESCRIPTION OF THE INVENTION

To achieve the aforesaid objects, the technical means and effects of the invention are described in detail below with embodiments in reference to the accompanying drawings.

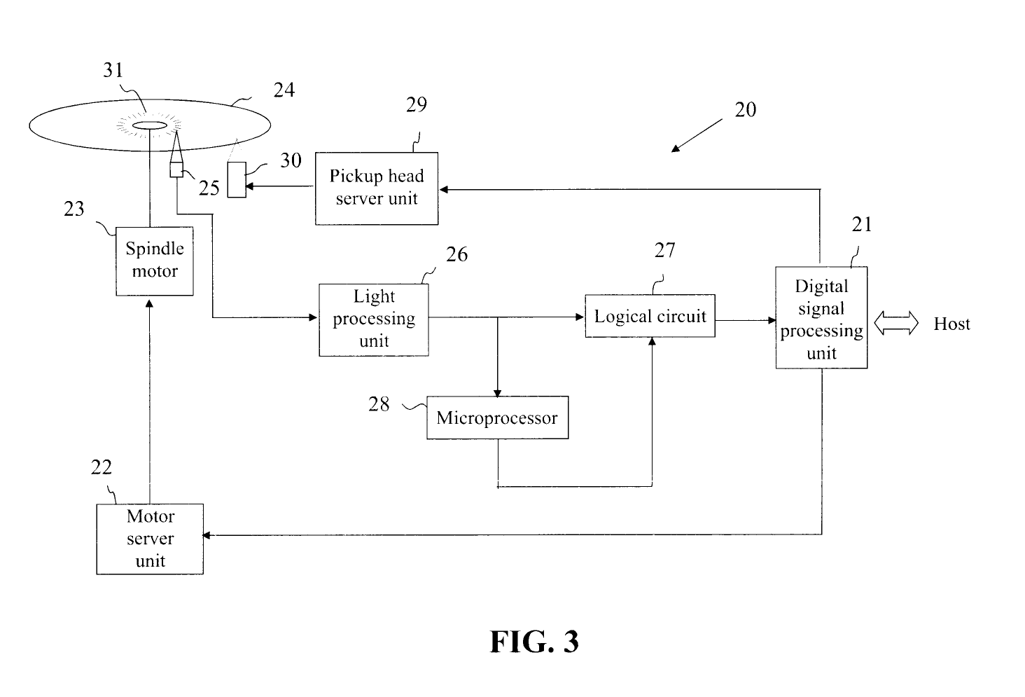

FIG. 3 shows the configuration of the compensating device in a light-scribe system 20 according to the invention. The light-scribe system 20 comprises a digital signal processing unit 21, a motor server unit 22, a spindle motor 23, an optical disc 24, a light emitter 25, a light processing unit 26, a logical circuit 27, a microprocessor 28, a pickup head server unit 29, and a pickup head 30. The digital signal processing unit 21 controls the motor server unit 22 to drive the rotation of optical disc 24 by the spindle motor 23. The light emitter 25 detects the rotating angle of optical disc 24 and transmits the signal to the light processing unit 26. The light processing unit 26 converts the rotating angle signal into pulse wave signal and sends it to logical circuit 27 and microprocessor 28. When microprocessor 28 detects the loss of pulse wave, it generates a replacing pulse wave and sends it to the logical circuit 27. The logical circuit 27 produces normal pulse wave and outputs it to the digital signal processing unit 21 Based on the signal received, the digital signal processing unit 21 controls the position of pickup head 30 through the pickup head server unit 29, and at the same time, controls the rotation angle of optical disc 24 driven by spindle motor 23 through the motor server unit 22 to achieve the positioning of pickup head 30.

The optical disc 24 has a spoke ring 31 on the non-data side. The light-scribe system 20 is disposed with a light emitter 25 nearby the spoke ring 31 where the light emitter 25 projects a light beam to the spoke ring 31 and receives the reflected light beam from the spoke ring 31, and transmits the reflected light signal to the light processing unit 26. Based on the intensity of reflected light, the light processing unit 26 converts the signal into pulse wave signal and sends the signal to the logical circuit 27 and microprocessor 28.

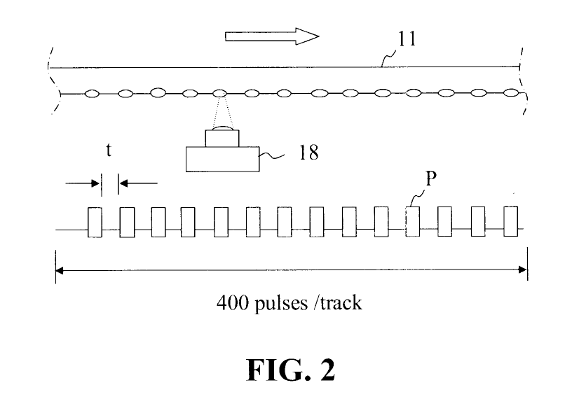

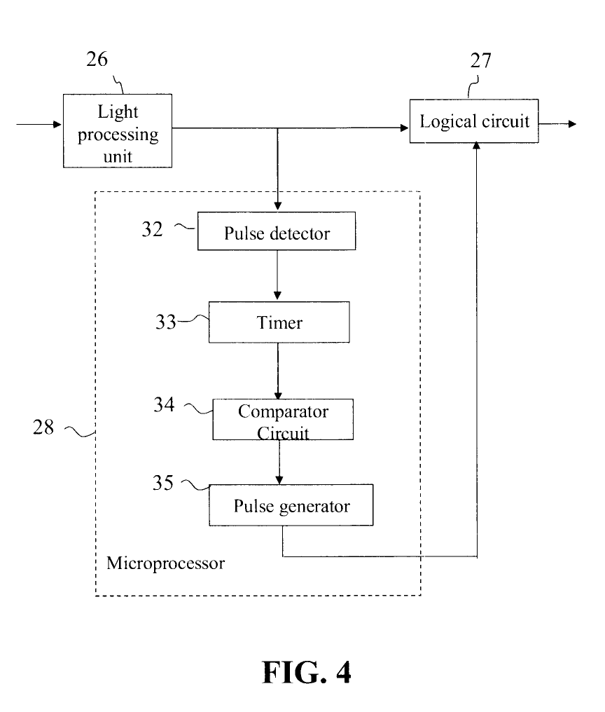

As shown in FIG. 4, the microprocessor 28 further comprises a pulse detector 32, a timer 33, a comparator circuit 34 and a pulse generator 35. The pulse wave output by the light processing unit 26 to the microprocessor 28 first passes through the pulse detector 32 where the pulse detector 32 detects the interruption of pulse wave signals output by the light processing unit 26 and transmits the information to the counter 33 for calculating the time of pulse interruption, that is, the interval between the end of the previous pulse and the generation of the next pulse t (refer to FIG. 2). The comparator circuit 34 then compares the pulse interruption time t against a preset threshold to screen pulse interruption time t that exceeds the threshold. The pulse generator 35 then generates a replacing wave at predefined cycle when pulse interruption time t exceeds the threshold, sends the generated pulse wave to the logical circuit 27, and promptly stops the generation of replacing pulse waves when the pulse interruption time t falls back below the threshold. The logical circuit 27 receives the pulse wave signals from the light processing unit 26 and pulse generator 35; under normal circumstances, it outputs directly the pulse wave from the light processing unit 26; when the pulse wave from the light processing unit 26 is lost, it compensates the loss with the replacing pulse wave from the pulse generator 35 and outputs the replacing pulse wave to maintain the normal count of pulses.

Referring to FIG. 3 the logical circuit 27 is connected to a digital signal processing unit 21. The digital signal processing unit 21 receives the command from the host to activate or deactivate the light-scribe system 20, and in addition, receives pulse wave signal output by the logical circuit 27 and converts it into a digital signal to control the connected motor server unit 22 and pickup head server unit 29. The motor server unit 22 drives the spindle motor 23 to rotate the optical disc 24; the pickup head server unit 29 moves the radial location of pickup head 30 to position it relative to the optical disc 24.

Because the light-scribe system 20 rotates the optical disc 24 at a constant linear velocity (CLV) to mark the texts and graphics thereon. To maintain the CLV marking speed, the pickup head 30 has a predefined target turning speed at different radial locations on optical disc 24. Thus with the target velocity of the pickup head 30 at a specific radial location on optical disc 24 known, the predefined cycle for the pulse generator 35 to generate a pulse can be computed by the light emitter 25 turning one full track around the optical disc 24 crossing 400 equidistant spokes in the spoke ring 31. At the same time with predefined cycle known, the interval between pulse waves can be used as the preset threshold for pulse interruption time t. Once the time for intermittent output of pulse wave by the light processing unit 26 exceeds the preset threshold, the pulse generator 35 would generate a replacing pulse wave of corresponding cycle at the radial location of pickup head 30 on optical disc 24 and send it to the logical circuit 27 for pulse formation.

Thus in the label production of optical disc 24, first place the non-data side of optical disc 24 facing the pickup head 30 of optical disc drive, and command the activation of light-scribe system 20. The digital signal processing unit 21 transmits the signal to motor server unit 22. The motor server unit 22 controls the rotation of spindle motor 23, which drives the turning of optical disc 24. At the same time, the light emitter 25 projects a light beam to the spoke ring 31 of optical disc 24 and sends the reflected light beam received from the spoke ring 31 to the light processing unit 26. The light processing unit 26 converts the reflected light beam into pulse wave signal based on its intensity and sends the signal respectively to the logical circuit 27 and microprocessor 28. Referring to FIG. 4, the pulse wave input into the microprocessor 28 first passes through the pulse detector 32 where the pulse detector 32 detects the interruption of pulse output by the light processing unit 26. When there is pulse output interruption, the timer 33 is activated to calculate the interruption time. The comparator circuit 34 then compares the pulse interruption time to a preset threshold. If the interruption time is below the threshold, the pulse generator 35 will not generate a pulse wave at predefined cycle to the logical circuit 27. Instead the logical circuit 27 outputs directly the pulse wave signal output by the light processing unit 26. If the interruption time exceeds the threshold, it is determined that there is loss of pulse wave output by the light processing unit 26. In such event, the pulse generator 35 would generate a replacing pulse wave of predefined cycle and send it to the logical circuit 27 where it is combined with the signal output by the light processing unit 26 to form a pulse wave for output by the logical circuit 27. Once the pulse detector 32 detects the output of pulse wave from light processing unit 26 again, it stops the pulse generator 35 from generating pulse at predefined cycle. The logical circuit 28 again transmits pulse wave to the digital signal processing unit 21. The digital signal processing unit 21 counts the number of pulse waves passing through and converts it into a digital signal as basis for controlling the turning angle of spindle motor 23 to position accurately the angle and the position of pickup head 30 for label marking.

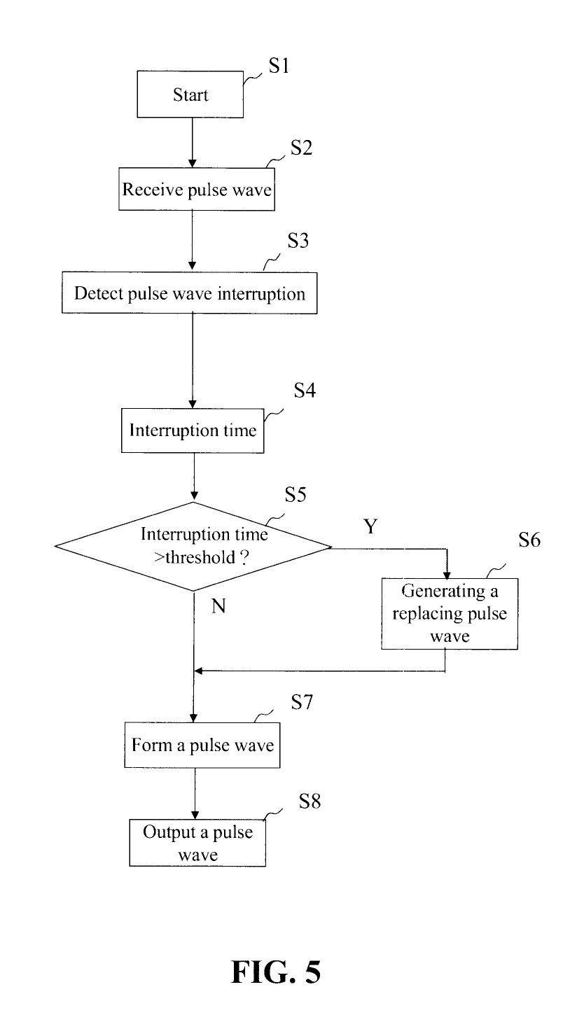

The method for the device to compensate the loss of spoke signal in a light-scribe system by generating a replacing pulse is illustrated in FIG. 5. The detailed steps of the flow process are described as follows:

Step S1: The light-scribe system starts the marking on optical disc;

Step S2: The light processing unit forms pulse wave signal based on the intensity of reflected light from the optical disc received by the light emitter and sends the signal respectively to the logical circuit and microprocessor:

Step S3: The microprocessor uses a pulse detector to detect the interruption of pulse waves output by light processing unit;

Step S4: Once the interruption of pulse wave output by the light processing unit is detected, the microprocessor immediately activates the counter to start counting the time of pulse wave interruption;

Step S5: The microprocessor uses comparator circuit to compare the interruption time to a preset threshold; if the interruption time is less than the threshold, proceed to step S7; if the interruption time is greater than the preset threshold, proceed to the next step;

Step S6: The microprocessor uses pulse generator to generate a replacing pulse wave of predefined cycle based on the radial location of pickup head on the optical disc;

Step S7: The logical circuit forms a pulse wave after receiving the normal pulse wave output by the light processing unit and the replacing pulse wave; and

Step S8: The logical circuit outputs the pulse wave it forms.

The device and method for compensating signal in a light-scribe system described above uses a microprocessor to detect the pulse wave interruption time on an ongoing basis. Once the interruption time exceeds a preset time, it is determined that there is loss of pulse wave output. A pulse generator instantly generates a pulse wave of predefined cycle based on the radial location of pickup head on the optical disc to compensate the poor reception or loss of pulse wave signal caused by the poor quality of spoke, disc or light receiving units, or the vibration of disc. This way, the correct positioning of pickup head is achieved, which helps prevent the deformation of label and improve the manufacturing and assembly quality of optical disc and light processing unit, thereby reducing the overall production cost.

The preferred embodiments of the present invention have been disclosed in the examples. However the examples should not be construed as a limitation on the actual applicable scope of the invention, and as such, all modifications and alterations without departing from the spirits of the invention and appended claims shall remain within the protected scope and claims of the invention.

What is claimed is:

1. A device for compensating signal in a light-scribe system, comprising:
a light processing unit for processing the reflected light signal from the spokes of an optical disc and forming a pulse wave;
a microprocessor for receiving the pulse wave from light processing unit, detecting any loss of pulse wave, and generating a replacing pulse wave; and
a logical circuit for receiving pulse wave from light processing unit and replacing pulse wave generated by the microprocessor and forming a pulse wave for output;
wherein when the logical circuit does not detect loss of pulse wave output by light processing unit, it outputs the pulse wave from the light processing unit; when loss of pulse wave output by light processing unit is detected, the logical circuit outputs the replacing pulse wave instead.

2. The device for compensating signal in a light-scribe system according to claim 1, further comprising a light emitter that projects a light beam to the spoke of an optical disc, receives the reflected light signal from the spoke, and outputs it to the light processing unit.

3. The device for compensating signal in a light-scribe system according to claim 1, further comprising a digital signal processing unit and a pickup head, the digital signal processing unit, based on the pulse wave output by the logical circuit, controls the location and angle of a pickup head in label marking.

4. The device for compensating signal in a light-scribe system according to claim 1, wherein the microprocessor further comprises a pulse detector for detecting the interruption of pulse wave output by the light processing unit.

5. The device for compensating signal in a light-scribe system according to claim 1, wherein the microprocessor further comprises a pulse generator for generating a replacing pulse wave.

6. The device for compensating signal in a light-scribe system according to claim 5, wherein the replacing pulse wave generated by the pulse generator is a pulse wave of predefined cycle.

7. The device for compensating signal in a light-scribe system according to claim 6, wherein the pulse generator would stop the generation of pulse wave of predefined cycle once the microprocessor again detects the output of pulse wave by light processing unit.

8. The device for compensating signal in a light-scribe system according to claim 1, wherein the microprocessor further comprises a timer to Count the interruption time of pulse wave output by light processing unit.

9. The device for compensating signal in a light-scribe system according to claim 8, wherein the microprocessor further comprises a comparator to compare the interruption time of pulse wave output by light processing unit to a preset threshold and generates a replacing pulse wave if the interruption time is greater than the threshold.

10. A method for compensating signal in a light-scribe system comprising the steps of:
(1) activating the light-scribe system;
(2) receiving the reflected light of an optical disc to form pulse wave signal;
(3) detecting the loss of pulse wave signal; if there is no loss, go to step (5); if there is loss, proceed to the next step;
(4) generating a replacing pulse wave; and
(5) outputting a pulse wave.

11. The method for compensating signal in a light-scribe system according to claim 10, wherein the pulse wave signal received in step (2) is formed based on the intensity of reflected light from a spoke ring on a specific radius of an optical disc.

12. The method for compensating signal in a light-scribe system according to claim 10, wherein the pulse wave interruption time detected in step (3) is used as the basis for determining the loss of pulse wave signal.

13. The method for compensating signal in a light-scribe system according to claim 12, further comprising steps after step (3):
(3-1) counting the pulse wave interruption time; and
(3-2) comparing whether the interruption time is greater than a preset threshold? If the interruption time is less than the threshold, proceed to step (5); if the interruption time is greater than the threshold, proceed to step (4).

14. The method for compensating signal in a light-scribe system according to claim 13, wherein the pulse wave interruption time is the interval between the end of the previous pulse and the generation of the next pulse.

15. The method for compensating signal in a light-scribe system according to claim 13, wherein the threshold is determined in the following manner: the light-scribe system rotating the optical disc at a constant linear velocity, there being a target velocity at each radial location of the optical disc, and calculating the time required for the interval of pulse waves based on the number of spokes in the spoke ring on optical disc.

16. The method for compensating signal in a light-scribe system according to claim 15, wherein the replacing pulse wave of predefined cycle is generating in the following manner: the replacing pulse wave in step (4) being generated while the optical disc being rotated under a constant linear velocity, there being a target velocity at each radial location of the optical disc, and generating replacing pulse wave of predefined cycle based on the number of spokes in the spoke ring at different radial location on optical disc.

17. The method for compensating signal in a light-scribe system according to claim 16, wherein the number of spokes on the optical disc is 400.

18. The method for compensating signal in a light-scribe system according to claim 10, wherein in step (5) a pulse wave is formed after receiving the direct output of a pulse wave in step (2) and a replacing pulse wave in step (4).
